(19) United States
(12) Patent Application Publication
(10) Pub. No.: US 2026/0058283 A1
(43) Pub. Date: Feb. 26, 2026

(54) ENERGY STORAGE DEVICE AND VEHICLE

(71) Applicant: TOYOTA JIDOSHA KABUSHIKI KAISHA, Toyota-shi (JP)

(72) Inventor: Nobuyasu Nishiki, Toyokawa-shi (JP)

(73) Assignee: TOYOTA JIDOSHA KABUSHIKI KAISHA, Toyota-shi (JP)

(21) Appl. No.: 19/264,087

(22) Filed: Jul. 9, 2025

(30) Foreign Application Priority Data
Aug. 20, 2024 (JP) 2024-138501

(51) Int. Cl. H01M 50/249; H01M 50/209

(52) U.S. Cl. CPC H01M 50/249; H01M 50/209

(57) ABSTRACT

An energy storage device includes: a first energy storage stack and a second energy storage stack each including a plurality of energy storage cells; a lower case; a cross member partitioning the area inside the lower case; an electrical connection member including an extending portion extending along the cross member; and a first protective member and a second protective member that protect the electrical connection member. The first protective member includes a bottom and a pair of walls, and is fixed to an upper wall of the cross member. The extending portion passes between the walls. The second protective member includes a covering portion located between the walls and covering the extending portion. The second protective member is held by the first protective member in such a manner that the second protective member is in contact with upper ends of the walls.

### CROSS-REFERENCE TO RELATED APPLICATION

This application claims priority to Japanese Patent Application No. 2024-138501 filed on Aug. 20, 2024. The disclosure of the above-identified application, including the specification, drawings, and claims, is incorporated by reference herein in its entirety.

### BACKGROUND

### 1. Technical Field

The present disclosure relates to energy storage devices and vehicles including the energy storage device.

### 2. Description of Related Art

Japanese Unexamined Patent Application Publication No. 2023-046945 (JP 2023-046945 A) discloses an energy storage device. In this energy storage module, a plurality of battery modules (energy storage stacks) is housed in a housing case. A cross member is disposed between adjacent ones of the battery modules in the housing case, and a mount member that supports an upper case is provided on the cross member.

A damper is disposed between a vehicle body and a portion of the upper case that is located above the mount member. When a load is applied from below the housing case, the load is applied to the vehicle body through the cross member and the mount member. At this time, part of the load is absorbed by the damper disposed in a path through which the load is applied from the upper case to the vehicle body. As a result, the load that is applied to the vehicle body can be reduced.

### SUMMARY

The energy storage stacks housed in the housing case are electrically connected by electrical connection members. When a load is applied from the outside of the housing case, interference may occur between the electrical connection member and the energy storage stack.

The present disclosure was made in view of such an issue, and an object of the present disclosure is to provide an energy storage device that can reduce vibration of an electrical connection member and can also reduce interference between the electrical connection member and an energy storage stack when an external load is applied, and a vehicle including the energy storage device.

An energy storage device according to the present disclosure includes: a first energy storage stack and a second energy storage stack each including a plurality of energy storage cells; a lower case in which the first energy storage stack and the second energy storage stack are disposed; a cross member disposed between the first energy storage stack and the second energy storage stack and partitioning an area inside the lower case; an electrical connection member configured to electrically connect the first energy storage stack and the second energy storage stack, and including an extending portion extending above and along the cross member; and a first protective member and a second protective member that protect the electrical connection member. The first protective member includes a bottom and a pair of walls and is fixed to an upper wall of the cross member. The walls are connected to the bottom and facing each other in a crossing direction. The crossing direction is a direction crossing an extending direction of the extending portion. The extending portion passes between the walls. The second protective member includes a covering portion located between the walls and covering the extending portion. The second protective member is held by the first protective member in such a manner that the second protective member is in contact with upper ends of the walls.

With the above configuration, the lower case has increased rigidity in the area where the cross member is fixed. This reduces deformation of the peripheral portion of the cross member when an external impact is applied to the lower case. Accordingly, an external force is less likely to be applied to the extending portion of the electrical connection member that extends above and along the cross member. This can reduce deformation of the electrical connection member and can also reduce interference between the electrical connection member and the energy storage stack. The extending portion passes between the walls of the first protective member, which can further reduce interference of the extending portion with the energy storage stack. Moreover, the second protective member held by the first protective member includes the covering portion that covers the extending portion of the electrical connection member. This can reduce vibration and impact that are applied to the electrical connection member.

The energy storage device according to the present disclosure may further include an upper member closing the lower case and covering the first energy storage stack and the second energy storage stack from above. In this case, an upper surface of the second protective member may be in contact with the upper member, and a clearance may be provided between a lower end of the covering portion and the bottom.

In the above configuration, a clearance is provided between the bottom of the first protective member and the covering portion covering the extending portion of the electrical connection member. Therefore, a load from the upper member side is transferred to the cross member through the walls of the first protective member. This can reduce transfer of the load to the extending portion covered by the covering portion.

In the energy storage device according to the present disclosure, upper surfaces of the walls may be flat. The second protective member may include an upper end portion including the upper surface of the second protective member, located on top of the covering portion, and extending in the crossing direction. The upper end portion may include a protruding portion protruding from the covering portion in the crossing direction when viewed from below. In this case, the protruding portion may include an inclined portion being in contact with inner ends of the upper surfaces of the walls and sloping upward toward the outside in the crossing direction. The inner ends are ends located on the inner side in the crossing direction.

In this configuration, the protruding portion of the second protective member includes the inclined portion. Therefore, when a load is applied from above the upper member, the walls of the first protective member are deformed so as to move apart. In addition to this deformation, the clearance provided between the lower end of the second protective member and the bottom of the first protective member can further reduce the load that is applied to the electrical connection member.

A vehicle according to the present disclosure includes a vehicle body and the above energy storage device mounted on the vehicle body.

With the above configuration, the vehicle includes the above energy storage device. This can reduce vibration of the electrical connection member and can reduce interference between the electrical connection member and the energy storage stack, thereby reducing short-circuiting of the energy storage stack.

In the vehicle according to the present disclosure, the vehicle body may include a floor panel, and the energy storage device may be disposed below the floor panel. In this case, the vehicle may further include a buffer member disposed between the floor panel and the energy storage device. The buffer member may be disposed above the first protective member and the second protective member.

With the above configuration, the buffer member can reduce an external force that is transferred to the floor panel when an external impact is applied to the energy storage device. Moreover, by mounting the energy storage device on the vehicle body such that the energy storage device is pressed against the buffer member, the first protective member and the second protective member can be pressed against the cross member by the reaction force. This can reduce vibration of the first protective member and the second protective member, and therefore, can reduce vibration of the electrical connection member covered by the second protective member.

In the vehicle according to the present disclosure, the vehicle body may include a framework member. The energy storage device may include an upper member closing the lower case and covering the first energy storage stack and the second energy storage stack from above. In this case, the vehicle may further include a buffer member disposed between the upper member and the framework member. The buffer member may be disposed above the first protective member and the second protective member.

With the above configuration, the buffer member can reduce an external force that is transferred to the framework member of the vehicle when an external impact is applied to the energy storage device. Moreover, by mounting the energy storage device on the vehicle body such that the energy storage device is pressed against the buffer member, the first protective member and the second protective member can be pressed against the cross member by the reaction force. This can reduce vibration of the first protective member and the second protective member, and therefore, can reduce vibration of the electrical connection member covered by the second protective member.

In the vehicle according to the present disclosure, the energy storage device may include an upper member closing the lower case and covering the first energy storage stack and the second energy storage stack from above. In this case, the vehicle may further include a protective cover that covers part of the upper member from above such that a space is provided between the protective cover and the upper member. The protective cover may include a pair of side walls disposed spaced apart from each other in an extending direction of the cross member. The first protective member and the second protective member may be disposed below each of the lower surfaces of the side walls.

With the above configuration, the first protective member and the second protective member can be pressed toward the cross member via the upper member by the load from the protective cover. This can reduce vibration of the first protective member and the second protective member, and therefore, can reduce vibration of the electrical connection member covered by the second protective member.

The present disclosure provides an energy storage device that can reduce vibration of an electrical connection member and can also reduce interference between the electrical connection member and an energy storage stack when an external load is applied, and a vehicle including the energy storage device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a vehicle according to a first embodiment;

FIG. 2 shows an energy storage device according to the first embodiment fixed to a vehicle body;

FIG. 3 is an exploded perspective view of the energy storage device according to the first embodiment;

FIG. 4 is a plan view showing the inside of the energy storage device according to the first embodiment;

FIG. 5 is a cross-sectional view taken along line V-V in FIG. 4; and

FIG. 6 is a schematic sectional view showing the positional relationship between a protective cover and each of first and second protective members of the energy storage device in a vehicle according to a second embodiment.

### DETAILED DESCRIPTION OF EMBODIMENTS

Hereinafter, embodiments of the present disclosure will be described in detail with reference to the drawings. In the following embodiments, the same or common portions are denoted by the same signs throughout the drawings, and description thereof will not be repeated.

Although numbers, quantities, etc. may be mentioned in the embodiments described below, the scope of the present disclosure is not limited to those numbers, quantities, etc. unless otherwise specified. The individual components in the following embodiments may not be included in the present disclosure unless otherwise specified. When there is a plurality of embodiments, it is intended from the beginning that the characteristic portions of each embodiment may be combined as appropriate, unless otherwise specified.

### First Embodiment

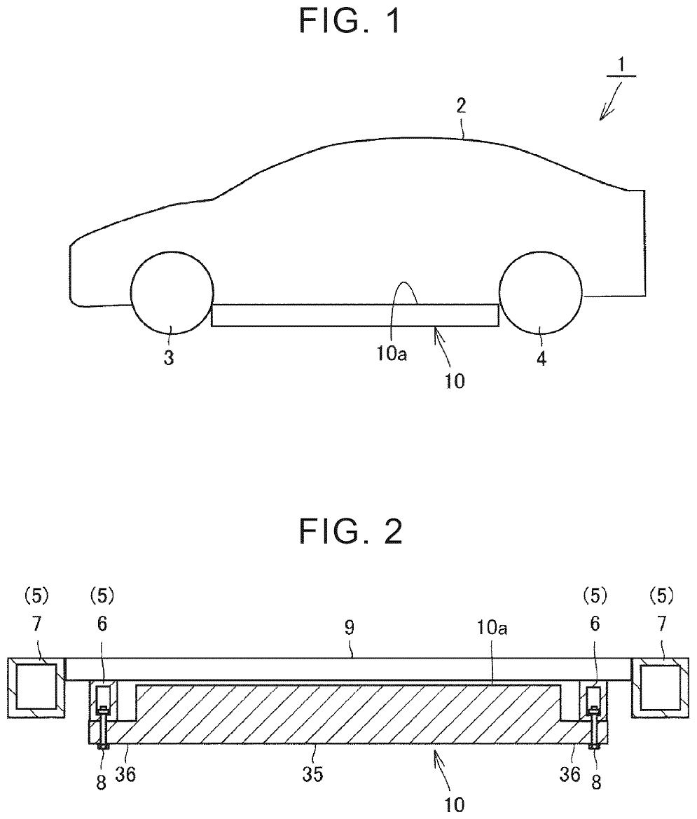

FIG. 1 is a schematic diagram of a vehicle according to a first embodiment. FIG. 2 shows an energy storage device according to the first embodiment fixed to a vehicle body. A vehicle 1 according to the first embodiment will be described with reference to FIGS. 1 and 2.

The vehicle 1 is a hybrid electric vehicle, a plug-in hybrid electric vehicle, or a battery electric vehicle.

The vehicle 1 includes a vehicle body 2, front wheels 3, rear wheels 4, and an energy storage device 10. The vehicle body 2 includes a framework member 5. The energy storage device 10 has an upper surface 10a. The upper surface 10a may also serve as a floor member that defines the inside of a vehicle cabin.

The framework member 5 includes a pair of side members 6 and a pair of side sills 7. One of the side sills 7 is disposed at one of both ends of the vehicle 1 in the width direction of the vehicle 1, and the other side sill 7 is disposed at the other end of the vehicle 1 in the width direction of the vehicle 1. Each of the side members 6 is disposed inward of a corresponding one of the side sills 7 at a distance. The side members 6 and the side sills 7 extend along the front-rear direction of the vehicle 1.

The side members 6 are spaced apart from each other in the width direction of the vehicle 1. A body 35 of the energy storage device 10 is disposed in the space between the side members 6. A space is provided between the body 35 and each of the side members 6. This can reduce the impact that is applied to the energy storage device 10 even when the vehicle 1 is involved in a side collision.

A fixed portion 36 is provided at one of both sides of the body 35 in the width direction of the vehicle 1, and another fixed portion 36 is provided at the other side of the body 35 in the width direction of the vehicle 1. Each of the fixed portions 36 is fixed to a corresponding one of the side members 6 by a fastening member 8.

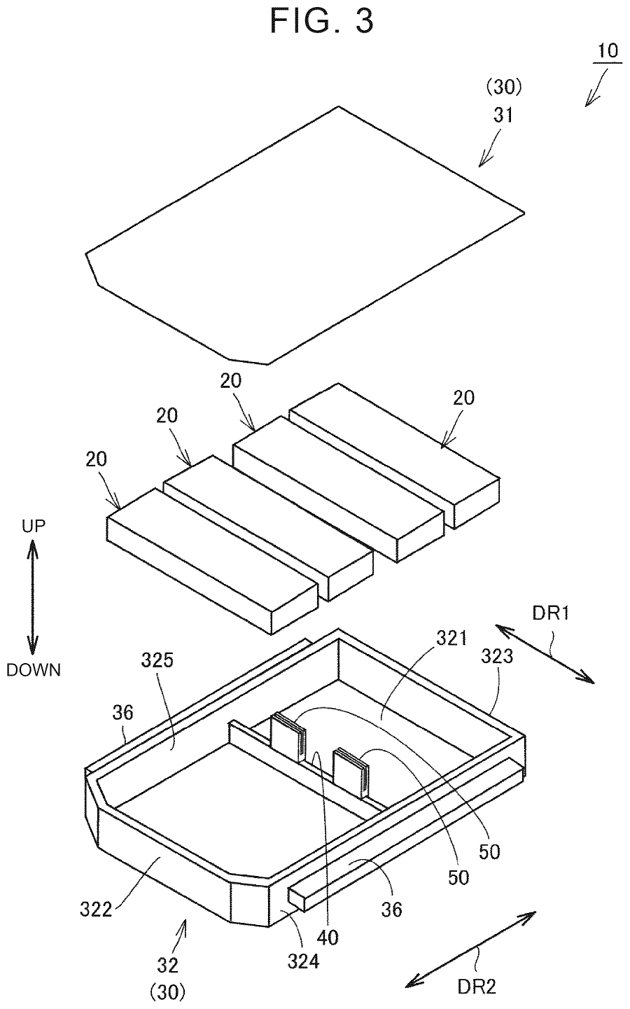

The framework member 5 further includes a vehicle body-side cross member 9. The vehicle body-side cross member 9 is provided above the energy storage device 10 so as to extend from one of the side sills 7 to the other side sill 7. The upper surface 10a of the energy storage device 10 is fixed to the vehicle body-side cross member 9. The upper surface 10a is formed by an upper member 31 (see FIG. 3) described later.

The above description illustrates an example in which the framework member 5 includes the pair of side members 6 and the pair of side sills 7. However, the present disclosure is not limited to this. The pair of side sills 7 may also serve as the pair of side members 6. In this case, the side members 6 may be omitted, and each of the fixed portions 36 may be fixed to a corresponding one of the side sills 7.

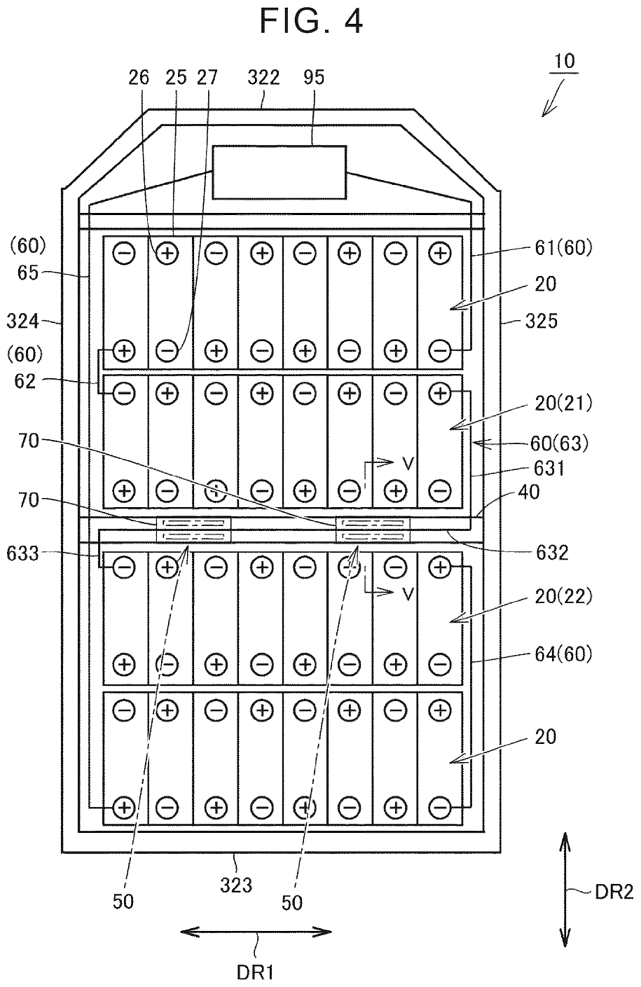

FIG. 3 is a schematic exploded perspective view of the energy storage device according to the first embodiment. FIG. 4 is a schematic plan view showing the inside of the energy storage device according to the first embodiment. The energy storage device 10 will be described in detail with reference to FIGS. 3 and 4. For convenience, second protective members 70 are not shown in FIG. 3, and the fixed portions 36 shown in FIG. 3 are not shown in FIG. 4.

As shown in FIGS. 3 and 4, the energy storage device 10 includes a plurality of energy storage stacks 20, a housing case 30, a cross member 40, a plurality of first protective members 50, a plurality of electrical connection members 60, a plurality of second protective members 70, and an electronic device 95.

Each of the energy storage stacks 20 includes a plurality of energy storage cells 25. These energy storage cells 25 are arranged in a first direction (DR1). In the present embodiment, the first direction is parallel to the width direction of the vehicle 1 when the energy storage device 10 is mounted on the vehicle body 2.

Each of the energy storage cells 25 is, for example, a secondary cell such as a nickel metal hydride cell or a lithium-ion cell. Each of the energy storage cells 25 may be a cell using a liquid electrolyte or a cell using a solid electrolyte. Each of the energy storage cells 25 may be a capacitor that can be charged and discharged.

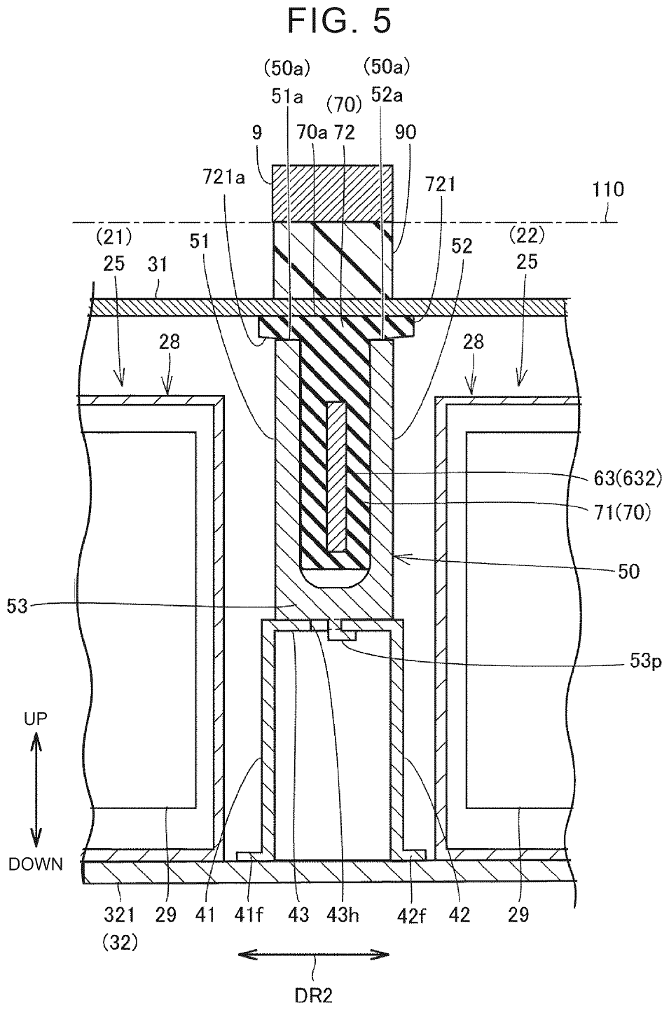

Specifically, each of the energy storage cells 25 includes a housing 28 (see FIG. 5) and an electrode assembly 29 (see FIG. 5). The electrode assembly 29 is housed in the housing 28. The electrode assembly 29 may be a stacked electrode assembly in which an anode sheet, a separator, and a cathode sheet are stacked, or may be a wound electrode assembly in which an anode sheet, a separator, and a cathode sheet are wound.

Each of the energy storage cells 25 includes a cathode external terminal 26 and an anode external terminal 27. In each of the energy storage stacks 20, the energy storage cells 25 are connected in series by a busbar. The energy storage cells 25 are disposed such that the cathode external terminals 26 and the anode external terminals 27 are alternately arranged in the first direction. The energy storage cells 25 are arranged in each of the energy storage stacks 20.

The energy storage stacks 20 are arranged side by side in a second direction (DR2). The second direction is a direction perpendicular to the first direction. In the present embodiment, the second direction is parallel to the front-rear direction of the vehicle 1 when the energy storage device 10 is mounted on the vehicle body 2.

The housing case 30 includes an upper member 31 and a lower case 32. The lower case 32 is generally in the shape of a box that is open on top. The energy storage stacks 20 are disposed in the lower case 32.

The lower case 32 includes the body 35 and the fixed portions 36. The body 35 includes a bottom wall 321, a first wall 322, a second wall 323, and side walls 324, 325. The first wall 322, the second wall 323, and the side walls 324, 325 are provided so as to stand from the peripheral edge of the bottom wall 321.

The first wall 322 and the second wall 323 face each other in the second direction. The side walls 324, 325 face each other in the first direction. One of the fixed portions 36 is provided on the outer surface of the side wall 324, and the other fixed portion 36 is provided on the outer surface of the side wall 325.

The upper member 31 is generally in the shape of a flat plate. The upper member 31 covers the energy storage stacks 20 from above and closes the open space of the lower case 32. The space between the upper member 31 and the energy storage stack 20 may be filled with a sealing member. The sealing member may have insulating properties. The upper member 31 may also serve as a floor panel, in addition to serving as a lid member that closes the open space of the lower case 32 as described above.

The cross member 40 is fixed to the lower case 32. The cross member 40 is made of a metal member such as steel use stainless (SUS). The cross member 40 extends along the first direction The cross member 40 partitions the area inside the lower case 32. Specifically, the cross member 40 divides the area inside the lower case 32 into two areas in which the energy storage stacks are disposed. Two energy storage stacks 20 are disposed in each of the two areas.

The energy storage stacks 20 includes a first energy storage stack 21 and a second energy storage stack 22 that are disposed spaced apart from each other in the second direction. The first energy storage stack 21 and the second energy storage stack 22 are disposed adjacent to each other in the second direction, and the cross member 40 is disposed in the space between the first energy storage stack 21 and the second energy storage stack 22.

The first protective members 50 extend upward from the cross member 40. The first protective members 50 are fixed to the cross member 40. An up-down direction is a direction perpendicular to the first direction and the second direction. The first protective members 50 are disposed spaced apart from each other in the first direction.

Each of the second protective members 70 is provided at a position of a corresponding one of the first protective members 50. Each of the second protective members 70 is held by a corresponding one of the first protective members 50. The first protective member 50 and the second protective member 70 will be described in detail later with reference to FIG. 5.

The electronic device 95 is disposed to one side of the energy storage stacks 20 in the second direction. The electronic device 95 is, for example, a battery electronic control unit (ECU).

The electrical connection members 60 electrically connect in series the energy storage stacks 20 arranged side by side in the second direction. The electrical connection members 60 include electrical connection members 61, 62, 63, 64, and 65.

The electrical connection member 61 connects, for example, an anode of an energy storage module formed by the energy storage stacks 20 to the electronic device 95. The electrical connection member 62 electrically connects in series the two energy storage stacks 20 disposed in the area located to one side of the cross member 40 in the second direction.

The electrical connection member 63 electrically connects the first energy storage stack 21 and the second energy storage stack 22. More specifically, the electrical connection member 63 electrically connects a first energy storage module and a second energy storage module. The first energy storage module is formed by the two energy storage stacks 20 disposed in the area located to the one side of the cross member 40 in the second direction. The second energy storage module is formed by the two energy storage stacks 20 disposed in the area located to the other side of the cross member 40 in the second direction.

At least part of the electrical connection member 63 overlaps the cross member 40 and extends along the extending direction of the cross member 40, when viewed from above. The electrical connection member 63 includes a first routed portion 631, an extending portion 632, and a second routed portion 633. The first routed portion 631 extends from the first energy storage stack 21 toward the cross member 40 along the second direction.

The extending portion 632 overlaps the cross member 40 when viewed from above. The extending portion 632 is located above the cross member 40 and extends along the cross member 40. The width of the extending portion 632 in the second direction is smaller than the width of the cross member 40 in the second direction. The length of the extending portion 632 in the extending direction of the cross member 40 is smaller than the length of the cross member 40 in the extending direction of the cross member 40.

The second routed portion 633 is located on the opposite side from the first routed portion 631 in the first direction, and extends toward the second energy storage stack 22 along the second direction.

The electrical connection member 64 electrically connects in series the two energy storage stacks 20 disposed in the area located to the other side of the cross member 40 in the second direction. The electrical connection member 65 connects, for example, a cathode of the energy storage module formed by the energy storage stacks 20 to the electronic device 95.

The electrical connection members 61 to 65 are busbars. In the present embodiment, the electrical connection members 61 to 65 are, for example, metal members, and the first protective member 50 and the second protective member 70 are, for example, insulating members.

FIG. 5 is a schematic cross-sectional view taken along line V-V in FIG. 4. The cross member 40, the first protective member 50, and the second protective member 70 will be described in detail with reference to FIG. 5.

As shown in FIG. 5, the cross member 40 has a hollow structure. The cross member 40 includes a pair of side walls 41, 42 and an upper wall 43. The side walls 41, 42 face each other in the direction in which the first energy storage stack 21 and the second energy storage stack 22 are arranged, that is, in the second direction.

The side wall 41 is located closer to the first energy storage stack 21. A flange 41f is provided at the lower end of the side wall 41. The flange 41f extends toward the first energy storage stack 21. The side wall 42 is located closer to the second energy storage stack 22. A flange 42f is provided at the lower end of the side wall 42. The flange 42f extends toward the second energy storage stack 22.

The flanges 41f, 42f are fixed to the bottom wall 321 of the lower case 32 by, for example, welding or fastening. The cross member 40 is thus fixed to the lower case 32.

The upper wall 43 connects the upper ends of the side walls 41, 42. The upper wall 43 has a through hole 43h. An engagement portion 53p, which will be described later, is inserted through the through hole 43h.

The first protective member 50 includes a pair of walls 51, 52 and a bottom 53. The walls 51, 52 face each other in a crossing direction. The crossing direction is a direction crossing the extending direction of the extending portion 632. Specifically, the walls 51, 52 face each other in the second direction. The walls 51, 52 are disposed spaced apart from each other in the second direction. The extending portion 632 passes between the walls 51, 52. The walls 51, 52 are connected to the bottom 53. The wall 51 has an upper surface 51a, and the wall 52 has an upper surface 52a. The upper surfaces 51a, 52a are flat. The upper surfaces 51a, 52a are parallel to the second direction.

The bottom 53 rests on the upper wall 43 of the cross member 40. The lower surface of the bottom 53 is provided with the engagement portion 53p. The engagement portion 53p protrudes downward. The engagement portion 53p is inserted through the through hole 43h of the cross member 40 and engaged with a portion of the upper wall 43 that is located at the periphery of the through hole 43h. The first protective member 50 is thus fixed to the cross member 40. With this configuration, the first protective member 50 can be easily fixed. The first protective member 50 may be fixed to the cross member 40 by, for example, welding or fastening.

The second protective member 70 includes a covering portion 71 and an upper end portion 72. The covering portion 71 is disposed between the walls 51, 52. The covering portion 71 covers part of the extending portion 632. More specifically, the covering portion 71 covers a portion of the extending portion 632 that is located between the walls 51, 52. The covering portion 71 covers the extending portion 632 in such a manner that the covering portion 71 is in close contact with the peripheral surface of the extending portion 632. The covering portion 71 extends in the up-down direction. The covering portion 71 is sandwiched between the walls 51, 52.

A clearance is provided between the lower end of the covering portion 71 and the bottom 53 of the first protective member 50. With this configuration, when a load is transferred downward from the upper member 31 side, the load is transferred along the walls 51, 52 of the first protective member 50 to the cross member 40. This can reduce transfer of the load to the extending portion 632 covered by the covering portion 71.

The upper end portion 72 has an upper surface 70a of the second protective member 70, and extends in the crossing direction (more specifically, the second direction). The upper surface 70a is flat and is in contact with the inner surface of the upper member 31. The upper end portion 72 is located on top of the covering portion 71. The upper end portion 72 is connected to the covering portion 71. The upper end portion 72 has a protruding portion 721 protruding from the covering portion 71 in the crossing direction when viewed from below.

The protruding portion 721 is sandwiched between the upper member 31 and an upper surface 50a (i.e., the upper surfaces 51a, 52a) of the first protective member 50. The second protective member 70 is thus held by the first protective member 50 in such a manner that the second protective member 70 is in contact with the upper ends of the walls 51, 52. This can reduce vibration of the second protective member 70, and therefore, can reduce vibration of the extending portion 632 covered by the covering portion 71 of the second protective member 70.

The protruding portion 721 is in contact with at least the inner ends of the upper surfaces 51a, 52a of the walls 51, 52. The inner ends refer to the ends located on the inner side in the crossing direction. As long as the protruding portion 721 can push the walls 51, 52 in such a direction that the walls 51, 52 move apart as described below, the protruding portion 721 may be in contact with the inner portions of the upper surfaces 51a, 52a of the walls 51, 52, or may be in contact with the entire upper surfaces 51a, 52a of the walls 51, 52.

The protruding portion 721 has an inclined portion 721a that slopes upward toward the outside in the crossing direction. The inclined portion 721a forms the lower surface of the protruding portion 721.

Since the inclined portion 721a is provided in this manner, the walls 51, 52 of the first protective member 50 are pushed by the inclined portion 721a and deformed so as to move apart, when a load is applied downward from the upper member 31 side. In addition to this deformation, the clearance provided between the lower end of the second protective member 70 and the bottom 53 of the first protective member 50 can further reduce the load that is applied to the electrical connection member 63.

The vehicle 1 further includes a buffer member 90. The buffer member 90 is disposed between the vehicle body 2 and the upper member 31. More specifically, the buffer member 90 is disposed between the vehicle body-side cross member 9 and the upper member 31. The buffer member 90 is disposed above the first protective member 50 and the second protective member 70, and is sandwiched between the vehicle body-side cross member 9 and the upper member 31.

When the buffer member 90 is disposed in this manner, the buffer member 90 can reduce an external force that is transferred to the framework member 5 of the vehicle 1 when an external impact is applied to the energy storage device 10. Moreover, by mounting the energy storage device 10 on the vehicle body 2 such that the energy storage device 10 is pressed against the buffer member 90, the first protective member 50 and the second protective member 70 can be pressed against the cross member 40 by the reaction force. This can reduce vibration of the first protective member 50 and the second protective member 70, and therefore, can reduce vibration of the electrical connection member 63 covered by the second protective member 70.

The above description illustrates an example in which the upper member 31 serves as a floor panel and the buffer member 90 is disposed between the vehicle body-side cross member 9 and the upper member 31. However, the present disclosure is not limited to this. When the vehicle body 2 includes a floor panel 110 and the energy storage device 10 is disposed below the floor panel 110, the buffer member 90 may be disposed between the floor panel 110 and the upper member 31 instead of between the vehicle body-side cross member 9 and the upper member 31. In this case, the buffer member 90 is located above the first protective member 50 and the second protective member 70.

When the buffer member 90 is disposed in this manner, the buffer member 90 can reduce an external force that is transferred to the floor panel 110 when an external impact is applied to the energy storage device 10. Moreover, by mounting the energy storage device 10 on the vehicle body 2 such that the energy storage device 10 is pressed against the buffer member 90, the first protective member 50 and the second protective member 70 can be pressed against the cross member 40 by the reaction force. This can reduce vibration of the first protective member 50 and the second protective member 70, and therefore, can reduce vibration of the electrical connection member 63 covered by the second protective member 70.

As described above, in the energy storage device 10 according to the present embodiment, the lower case 32 has increased rigidity in the area where the cross member 40 is fixed. This reduces deformation of the peripheral portion of the cross member 40 when an external impact is applied to the lower case 32. Accordingly, an external force is less likely to be applied to the extending portion 632 of the electrical connection member 63 that extends above and along the cross member 40. This can reduce deformation of the electrical connection member 63 and can also reduce interference between the electrical connection member 63 and the energy storage stack 20 (specifically, the first energy storage stack 21 and/or the second energy storage stack 22). The extending portion 632 passes between the walls 51, 52 of the first protective member 50, which can further reduce interference of the extending portion 632 with the energy storage stack 20. Moreover, the second protective member 70 held by the first protective member 50 includes the covering portion 71 that covers the extending portion 632 of the electrical connection member 63. This can reduce vibration and impact that are applied to the electrical connection member 63.

### Second Embodiment

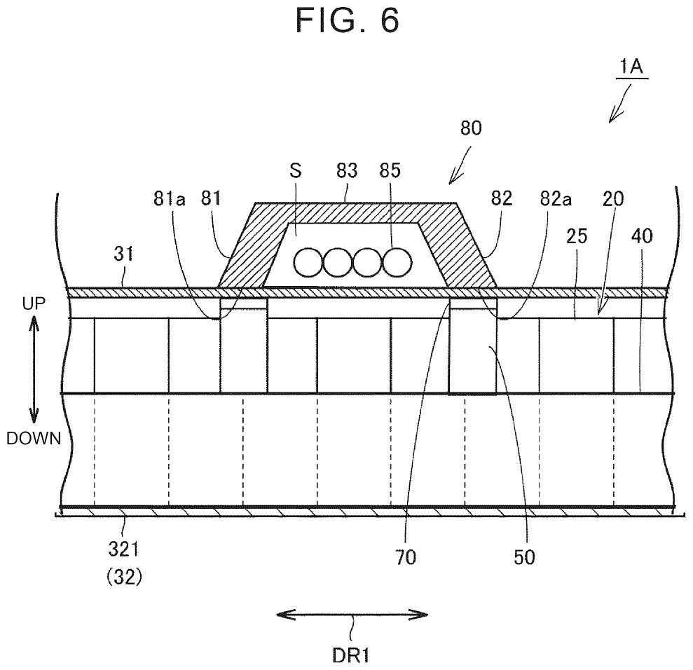

FIG. 6 is a schematic sectional view showing the positional relationship between a protective cover and each of the first protective member and the second protective member of the energy storage device in a vehicle according to a second embodiment. A vehicle 1A according to the second embodiment will be described with reference to FIG. 6.

As shown in FIG. 6, the vehicle 1A according to the second embodiment is different from the vehicle 1 according to the first embodiment in that the vehicle 1A includes a protective cover 80 and wires 85 and in the positions of the first protective member 50 and the second protective member 70. The configuration of the vehicle 1A is otherwise substantially the same as the configuration of the vehicle 1.

The protective cover 80 protects the wires 85 routed above the upper member 31. The protective cover 80 covers part of the upper member 31 from above the upper member 31 such that a space S is formed between the protective cover 80 and the upper member 31. The wires 85 are located inside the space S. The protective cover 80 is disposed so as to overlap part of the cross member 40 when viewed in the vertical direction. The protective cover 80 is disposed so as to overlap, for example, a middle portion of the cross member 40 in the extending direction of the cross member 40, when viewed from above. The protective cover 80 extends along a direction crossing the extending direction of the cross member 40. Specifically, the protective cover 80 extends along the second direction.

The protective cover 80 includes a pair of side walls 81, 82 and a ceiling 83. The side walls 81, 82 are disposed spaced apart from each other in the extending direction of the cross member 40. The side wall 81 has a lower surface 81a, and the side wall 82 has a lower surface 82a. The ceiling 83 connects the upper ends of the side walls 81, 82.

The first protective member 50 and the second protective member 70 are disposed below each of a lower surface 81a of the side wall 81 and a lower surface 82a of the side wall 82. The first protective member 50 and the second protective member 70 are sandwiched between the upper member 31 and the cross member 40 at each of the position below the lower surface 81a and the position below the lower surface 82a.

Even the vehicle 1A according to the second embodiment configured as described above has substantially the same effects as those of the vehicle 1 including the energy storage device 10 according to the first embodiment. Since the first protective member 50 and the second protective member 70 are disposed below each of the lower surface 81a of the side wall 81 and the lower surface 82a of the side wall 82, the first protective member 50 and the second protective member 70 can be pressed toward the cross member 40 via the upper member 31 by the load from the protective cover 80. This can reduce vibration of the first protective member 50 and the second protective member 70, and therefore, can reduce vibration of the electrical connection member 63 covered by the second protective member 70.

The first and second embodiments illustrate an example in which the first direction is parallel to the width direction of the vehicle, and the second direction is parallel to the front-rear direction of the vehicle. However, the present disclosure is not limited to this. The first direction may be parallel to the front-rear direction of the vehicle, and the second direction may be parallel to the width direction of the vehicle.

The first and second embodiments illustrate an example in which the energy storage stacks 20 are arranged in a row. However, the present disclosure is not limited to this, and the energy storage stacks 20 may be arranged in a matrix.

The embodiments disclosed herein are illustrative in all respects and are not restrictive. The scope of the present disclosure is set forth in the claims, and includes all modifications within the meaning and scope equivalent to the claims.

What is claimed is:

1. An energy storage device comprising:
a first energy storage stack and a second energy storage stack each including a plurality of energy storage cells;
a lower case in which the first energy storage stack and the second energy storage stack are disposed;
a cross member disposed between the first energy storage stack and the second energy storage stack and partitioning an area inside the lower case;
an electrical connection member configured to electrically connect the first energy storage stack and the second energy storage stack, the electrical connection member including an extending portion extending above and along the cross member; and
a first protective member and a second protective member that protect the electrical connection member, wherein:
the first protective member includes a bottom and a pair of walls and is fixed to an upper wall of the cross member, the walls being connected to the bottom and facing each other in a crossing direction, and the crossing direction being a direction crossing an extending direction of the extending portion;
the extending portion passes between the walls; and
the second protective member includes a covering portion located between the walls and covering the extending portion, and is held by the first protective member in such a manner that the second protective member is in contact with upper ends of the walls.

2. The energy storage device according to claim 1, further comprising an upper member closing the lower case and covering the first energy storage stack and the second energy storage stack from above, wherein:
an upper surface of the second protective member is in contact with the upper member; and
a clearance is provided between a lower end of the covering portion and the bottom.

3. The energy storage device according to claim 2, wherein:
upper surfaces of the walls are flat;
the second protective member includes an upper end portion, the upper end portion including the upper surface of the second protective member, being located on top of the covering portion, and extending in the crossing direction;
the upper end portion includes a protruding portion, the protruding portion protruding from the covering portion in the crossing direction when viewed from below; and
the protruding portion includes an inclined portion, the inclined portion being in contact with inner ends of the upper surfaces of the walls and sloping upward toward outside in the crossing direction, and the inner ends being ends located on an inner side in the crossing direction.

4. A vehicle comprising:
a vehicle body; and
the energy storage device according to claim 1, the energy storage device being mounted on the vehicle body.

5. The vehicle according to claim 4, wherein:
the vehicle body includes a floor panel;
the energy storage device is disposed below the floor panel;
the vehicle further includes a buffer member disposed between the floor panel and the energy storage device; and
the buffer member is disposed above the first protective member and the second protective member.
